(19) United States
(12) Patent Application Publication
(10) Pub. No.: US 2023/0284691 A1
(43) Pub. Date: Sep. 14, 2023

(54) Aerosol Generation Assembly Comprising an Aerosol Generation Device and a Cartridge with NFC

(71) Applicant: JT International SA, Geneva (CH)

(72) Inventors: Kyle Adair, Lisburn (GB); Peter Loveday, Epsom (GB); Olayiwola Olamiposi Popoola, Walton-on-Thames (GB)

(73) Assignee: JT International SA, Geneva (CH)

(21) Appl. No.: 18/019,667

(22) PCT Filed: Aug. 9, 2021
(86) PCT No.: PCT/EP2021/072197

§ 371 Date: Feb. 3, 2023

(30) Foreign Application Priority Data
Aug. 10, 2020 (EP) 20190304.4

(51) Int. Cl. A24F 40/42; A24F 40/465; A24F 40/65

(52) U.S. Cl. CPC A24F 40/42; A24F 40/465; A24F 40/65

(57) ABSTRACT

An aerosol generation assembly includes an aerosol generation device and a cartridge The device includes
a cavity defining an operation position of the cartridge wherein the cartridge is received in the cavity and is able to operate with the device, and
a tag reader arranged on the cavity surface and extending along an offset axis (A-A′).
The cartridge includes an electronic communication tag configured to store data and communicate this data to the tag reader when the cartridge is in the operation position.
The tag is arranged on the cartridge surface so as when the cartridge is in the operation position, the tag and the tag reader are offset along the offset axis (A-A′).

### FIELD OF THE INVENTION

The present invention concerns an aerosol generation assembly comprising an aerosol generation device and a cartridge.

### BACKGROUND OF THE INVENTION

Different types of aerosol generation assembly are already known in the art. Generally, such assemblies comprise a storage portion for storing an aerosol forming precursor, which can comprise for example a liquid or a solid. A heating system is formed of one or more electrically activated resistive heating elements arranged to heat said precursor to generate the aerosol. The aerosol is released into a flow path extending between an inlet and outlet of the device. The outlet may be arranged as a mouthpiece, through which a user inhales for delivery of the aerosol.

In some aerosol generation assemblies, the precursor is stored in a removable cartridge. The aerosol generation assembly comprises then an aerosol generation device which defines a cavity in which the cartridge may be inserted. In order to attach the removable cartridge to the device body, a screw-threaded connection can for example be used. When the cartridge is assembled to the aerosol generation device, the cartridge is said to be in an operation position and the device is able to generate the aerosol. When the precursor is consumed, the cartridge can be easily removed and replaced.

Some known aerosol generation assemblies comprise also an antenna arranged inside the device cavity and a corresponding tag arranged on the cartridge so that the tag faces the antenna when the cartridge is in the operational position. Therefore, it is possible for the device to identify the corresponding cartridge and optionally read on the tag additional data associated to the cartridge.

Therefore, the disposition of the tag on the cartridge is determined by the position of the antenna inside the device cavity which represents some design constraints for the cartridge. In particular, the tag needs to be arranged on the cartridge so that in the operational position it faces the antenna in the device cavity. This leads to a positioning of the tag which makes the tag subject to material deterioration when inserting the cartridge, which enables possible tamper attempts on the tag and which is unaesthetical for the user.

### SUMMARY OF THE INVENTION

One of the aims of the present invention is to provide an aerosol generation assembly which solves the above mentioned issues.

For this purpose, the invention relates to an aerosol generation assembly comprising an aerosol generation device and a cartridge; the aerosol generation device comprising a device body extending along a device axis and comprising: a cavity delimited by a cavity surface and defining an operation position of the cartridge wherein the cartridge is received in the cavity and is able to operate with the aerosol generation device, and a tag reader arranged on the cavity surface and extending along an offset axis; the cartridge comprising a cartridge body defining a cartridge surface, and an electronic communication tag configured to store data and communicate this data to the tag reader when the cartridge is in the operation position ; wherein the electronic communication tag is arranged on the cartridge surface so as when the cartridge is in the operation position, the electronic communication tag and the tag reader are offset along the offset axis.

Indeed, using these features, the tag is offset from the antenna when the cartridge is in operational position which enables to reduce the design constraints on the cartridge. Particularly, such a respective position of the tag and antenna may reduce the device thickness as well as mechanical friction between these elements. Additionally, the tag may be placed under the mouthpiece so that it is hided and more protected from material deterioration and tamper attempts.

The aerosol generation assembly according to the invention comprises one or more of the following features, taken solely, or according to any technical feasible combination:
the offset axis is parallel to the device axis;
the cartridge is in the operation position, each of the electronic communication tag and the tag reader extends in a respective plane, the two respective planes being separated and parallel;
when the cartridge is in the operation position, the electronic communication tag and the tag reader are arranged away from each other along to the offset axis or overlap each other along the offset axis according to less than 25 % of the electronic communication tag area;
the aerosol generation assembly further comprises a mouthpiece designed to cover a part of the cartridge body and defining an internal volume between at least a delimiting wall of said part and an internal surface of the mouthpiece, the electronic communication tag being arranged in the internal volume;
the cartridge body comprises an airflow path defining an outlet formed on the mouthpiece, at least a part of the airflow path and the electronic communication tag extending in a same plane;
said part of the airflow path extends between the delimiting wall and a side wall of the cartridge body;
the cartridge body extends along a cartridge axis coinciding with the device axis when the cartridge is in the operation position;
the electronic communication tag extending parallel to the cartridge axis;
the electronic communication tag extends in a plane extending at equidistance from two parallel side walls of the cartridge body;
to be placed in the operational position, the cartridge is configured to be received in the cavity according to two different orientations, the electronic communication tag being able to communicate the data to the tag reader when the cartridge is in the operation position according to either orientation;
the cartridge body comprises a storage portion for storing an aerosol forming precursor and delimited by walls made of glass or plastic materials; and
the tag reader consists of a dielectric support, a chip and an antenna, the dielectric support being directly fixed to the cavity surface, the dielectric support being devoid of ferrite.

### BRIEF DESCRIPTION OF THE DRAWINGS

The invention and its advantages will be better understood upon reading the following description, which is given solely by way of non-limiting example and which is made with reference to the appended drawings, in which:

FIG. 1 is a cross-sectional view of an aerosol generation assembly according to the invention, the aerosol generation assembly comprising an aerosol generation device and a cartridge in an operational position;

FIG. 2 is a perspective view of the cartridge of FIG. 1, and

FIG. 3 is a cross-sectional view of the cartridge of FIG. 2.

### DETAILED DESCRIPTION OF THE INVENTION

Before describing the invention, it is to be understood that it is not limited to the details of construction set forth in the following description. It will be apparent to those skilled in the art having the benefit of the present disclosure that the invention is capable of other embodiments and of being practiced or being carried out in various ways.

As used herein, the term “aerosol generation device” or “device” may include a vaping device to deliver an aerosol to a user, including an aerosol for vaping, by means of aerosol generating unit (e.g. an aerosol generating element which generates vapor which condenses into an aerosol before delivery to an outlet of the device at, for example, a mouthpiece, for inhalation by a user). The device may be portable. “Portable” may refer to the device being for use when held by a user. The device may be adapted to generate a variable amount of aerosol, e.g. by activating a heater system for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation to enable a variable amount of vapor to be provided (so as to mimic the effect of smoking a conventional combustible smoking article such as a cigarette, cigar or pipe, etc.). The device may include a temperature regulation control to drive the temperature of the heater and/or the heated aerosol generating substance (aerosol pre-cursor) to a specified target temperature and thereafter to maintain the temperature at the target temperature that enables efficient generation of aerosol.

As used herein, the term “aerosol” may include a suspension of precursor as one or more of: solid particles; liquid droplets; gas. Said suspension may be in a gas including air. Aerosol herein may generally refer to/include a vapor. Aerosol may include one or more components of the precursor.

As used herein, the term “aerosol-forming precursor” or “precursor” or “aerosol-forming substance” or “substance” or “vaporizable material” is used to designate any material that is vaporizable in air to form aerosol. Vaporisation is generally obtained by a temperature increase up to the boiling point of the vaporization material, such as at a temperature up to 400° C., preferably up to 350° C. The vaporizable material may, for example, comprise or consist of an aerosol-generating liquid, gel, or wax or the like or an aerosol -generating solid that may be in the form of a rod, which contains processed tobacco material, a crimped sheet or oriented strips of reconstituted tobacco (RTB), or any combination of these. The vaporizable material may comprise one or more of: nicotine; caffeine or other active components. The active component may be carried with a carrier, which may be a liquid. The carrier may include propylene glycol or glycerin. A flavoring may also be present. The flavoring may include Ethylvanillin (vanilla), menthol, Isoamyl acetate (banana oil) or similar.

### DESCRIPTION OF AN EMBODIMENT OF THE INVENTION

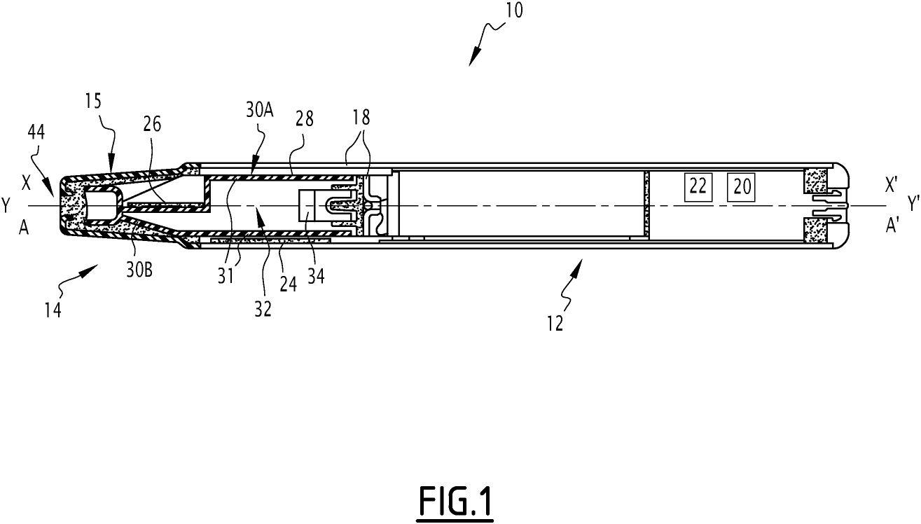

An aerosol generation assembly 10 according to the invention is shown on FIG. 1. The aerosol generation assembly 10 comprises an aerosol generation device 12 and a cartridge 14. Advantageously, the aerosol generation assembly 10 further comprises a mouthpiece 15 which can be a part of the aerosol generation device 12 or the cartridge 14.

The aerosol generation device 12 comprises a device body extending along a device axis X-X′. The device body comprises a cavity 16 delimited by a cavity surface 18. The cavity 16 is designed to receive the cartridge 14 and defines an operation position of the cartridge 14 wherein the cartridge 14 is received in the cavity 16 and is able to operate with the aerosol generation device 12 to generate aerosol. Particularly, in the operation position, the cartridge 14 is connected to the device 12 and is able to heat the precursor to generate aerosol. The cavity surface 18 comprises advantageously a wall made at least partially of a dielectric material.

Referring to FIG. 1, the device body further delimits an inside part of the device 12 able to receive internal components, notably a power supply device 20 and a printed circuit board 22. The power supply device 20 comprises a battery, for example a rechargeable lithium-ion battery known in the art. The printed circuit board 22 comprises a plurality of electronic components configured to control the operation of the aerosol generation device 12. Particularly, the printed circuit board 22 comprises a controller (not showed) configured to control for example a voltage provided by the battery to the cartridge 14, and notably to a heater arranged in the cartridge 14 as it will be explained below.

The device body further comprises a tag reader 24 arranged on the cavity surface 18. The tag reader 24 extends along an axis A-A′ which will be referred as an offset axis A-A′ in the following. In particular, in the example of FIG. 1, the offset axis A-A′ is parallel to the device axis X-X′. The tag reader 24 is able to send a request signal towards at least an associated tag 26, for example by creating an electromagnetic field around, and to receive a data signal from the tag 26 in response to the request signal, for example by analyzing modifications of the electromagnetic field created by the tag 26. The data signal can contain at least a piece of information stored in the tag 26. Thus, the tag reader 24 is able to implement a passive communication with the tag 26. According to another embodiment, the tag reader 24 is also able to implement an active communication with the tag 26. Advantageously, the tag reader 24 is able to communicate with the associated tag 26 via an NFC protocol (Near-Field Communication protocol) or an RFID protocol (Radio-frequency identification protocol).

The tag reader 24 consists of a dielectric support notably made of plastic material, a chip and an antenna. The dielectric support is directly fixed to the cavity surface 18. Contrary to known aerosol generation devices, the dielectric support of the tag reader 24 according to the invention is devoid of ferrite. Usual tag readers comprise a ferrite support in order to direct the signal towards the tag. Usually, the design of the aerosol generation assembly ensures that the tag comes into close proximity adjacent to the antenna which ensures a very reliable connection. In the present invention, as it will be described below, the tag reader 24 and the tag 26 are purposely offset. By removing the ferrite support from the tag reader, the signal can close its natural loop, which ensures a sufficient connection between the tag reader 24 and the tag 26. In this way, the aerosol generation assembly 10 according to the invention enables a reliable connection between the tag reader 24 and the tag 26 despite the offset.

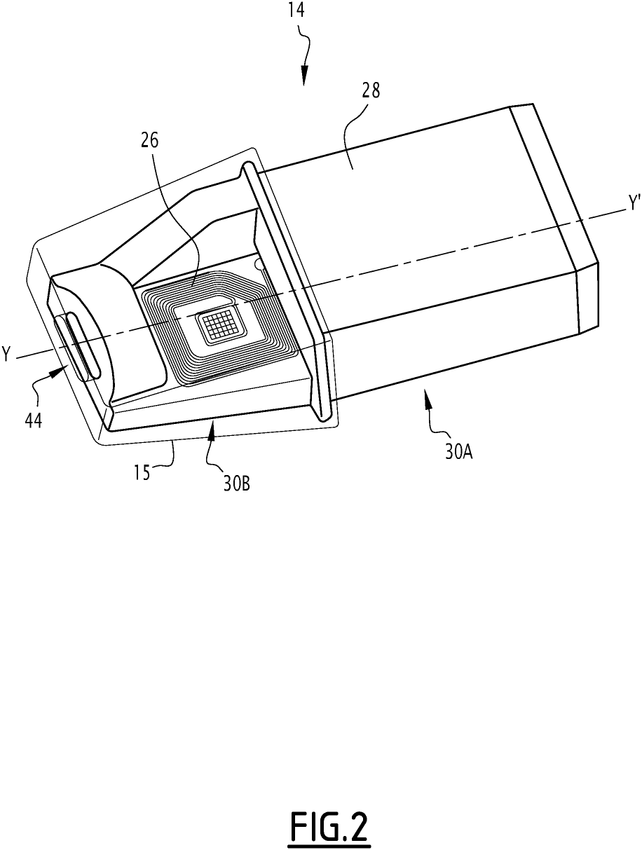

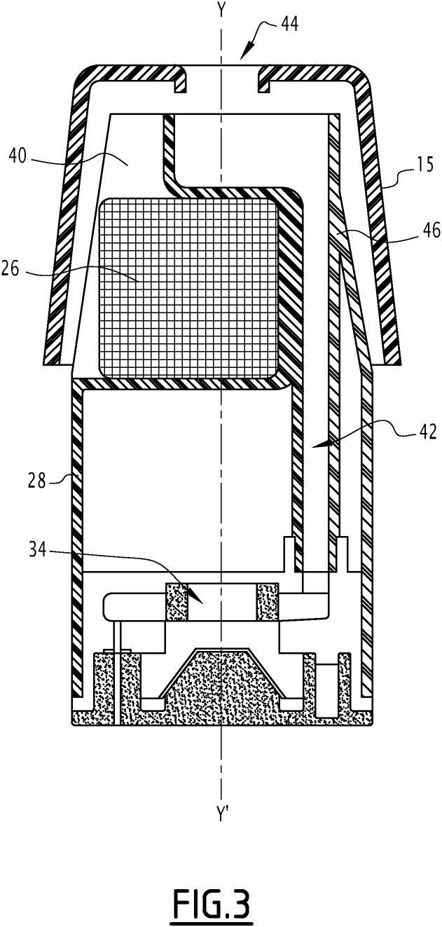

Referring to FIGS. 2 and 3, the cartridge 14 comprises a cartridge body defining a cartridge surface 28. In particular, the cartridge body presents a generally parallelepiped part 30A extending along a cartridge axis Y-Y′ with two pair of parallel side walls 31 (visible on FIG. 1) forming each a pair of parallel sides of the parallelepiped and a convergent part 30B extending between the parallelepiped part 30A and an extremity of the cartridge 14 along the cartridge axis Y-Y′. The cartridge axis Y-Y′ coincides with the device axis X-X′ when the cartridge 14 is in the operation position.

The cartridge surface 28 delimits a precursor storage portion 32 able to store a precursor. The precursor storage portion 32 is arranged both in the parallelepiped part 30A and in the convergent part 30B of the cartridge body. Advantageously, according to the invention, at least a part of walls of the cartridge surface 28 are made of glass or any other dielectric material, such a plastic material. The use of glass or dielectric materials allows a maximum antenna signal transmission contrary to metal for example which acts to shield and weaken antenna signals and ensures a reliable connection between the tag reader 24 and the tag 26 despite the offset.

The cartridge 14 further comprises a heater 34 able to heat the precursor to generate aerosol. The heater 34 of the cartridge 14 is connected electrically to the power supply device 20 of the device 12 through a pair of contacts arranged in both cartridge 14 and aerosol generation device 12. According to another embodiment of the invention, not shown, the heater of the cartridge may be coupled with a heating element arranged in the device 12 and powered by the power source of this device 12. In this case, heat is transmitted directly from the heating element of the device to the heater of the cartridge.

As already described, the cartridge 14 further comprises an electronic communication tag 26. The tag 26 is configured to store data and communicate this data to the tag reader 24 when the cartridge 14 is in the operation position. This data may for example comprise a cartridge unique identifier making it possible to authenticate the cartridge. The tag 26 extends notably in a plane and presents a square form. According to the invention, the tag 26 is arranged on the cartridge surface 30 so as when the cartridge 14 is in the operation position, the tag 26 and the tag reader 24 are offset along the offset axis X-X′. That is to say, that tag 26 and the tag reader 24 do not face each other completely. In particular, as shown on FIG. 1, when the cartridge 14 is in the operation position, the tag 26 and the tag reader 24 are arranged away from each other along to the offset axis X-X′. That is to say, that there is no overlap along the offset axis X-X′ between the tag 26 and the tag reader 24. In a variant, the tag 26 and the tag reader 24 overlap each other along the offset axis X-X′ according to less than 25 % of the tag 26 area, advantageously less than 10 % of the tag 26 area. As explained above, the offset axis X-X′ is parallel to the device axis A-A′. Therefore, the tag 26 and the tag reader 24 are offset along the device axis A-A′. This enable to reduce the design constraints for the cartridge 14. Indeed, the device 12 extending along the device axis A-A′, the offset along this axis offers more arrangement possibilities for the tag 26 and the tag reader 24. Particularly, such a respective position of the tag and antenna may reduce the device thickness. Moreover, such an offset prevents material deterioration as it prevents mechanical friction between these elements when inserting the cartridge 14.

As visible on FIG. 1, the tag 26 extends parallel to the cartridge axis Y-Y′. When the cartridge 14 is in the operation position, each of the tag 26 and the tag reader 24 extends in a respective plane, the two respective planes being separated and parallel. Such a disposition in parallel ensures a good connection between the tag 26 and the tag reader 24. In particular, the two respective planes being parallel compensates the fact that the tag 26 and the tag reader 24 are not exactly facing each other. In particular, as shown on FIG. 1, the tag 26 extends in a plane extending at equidistance from two of the parallel side walls 31 of the cartridge body. Therefore, to be placed in the operational position, the cartridge 14 is configured to be received in the cavity 16 according to two different orientations. In this case, in the embodiment where the heater 34 of the cartridge 14 is connected to the device 12 via a pair of contacts, these contacts are arranged symmetrically in respect with the plane of extension of the tag 26. Thus, the tag 26 is able to communicate the data to the tag reader 24 when the cartridge is in the operation position according to either orientation. This facilitates the use of the aerosol generation assembly 10 for a user as the cartridge 14 may be inserted in both orientation equivalently and with the same efficiency of data transmission between the tag 26 and the tag reader 24.

In reference to FIGS. 2 and 3, the mouthpiece 15 is designed to cover a part of the cartridge body and is for example fixed on this part. On FIG. 3, the mouthpiece 15 is represented transparent for the clarity of the figure but the skilled person will understand that the mouthpiece 15 is in fact transparent or not. The mouthpiece 15 defines an internal volume between at least a delimiting wall 40 of said part and an internal surface of the mouthpiece 15. Advantageously, according to the invention, the tag 26 is arranged in this internal volume. In particular, the tag 26 is arranged in the convergent part 30B of the cartridge body, away from the parallelepiped part 30A as it is visible on FIG. 2. Therefore, the tag 26 is hidden and protected by the mouthpiece 15 against material deterioration and tamper attempts.

In the example of FIG. 3, the cartridge body comprises an airflow path 42 defining an outlet 44 formed on the mouthpiece 15. The airflow path 42 is fluidly connected to the heater 34 and is able to conduct the flow of aerosol formed by the heater 34 towards the outlet 44. As shown on FIG. 3, the airflow path 42 extends between the delimiting wall 40 and a side wall 46 of the cartridge body along the cartridge axis Y-Y′ and opens up at a divergent extremity towards the outlet 44 forming a centered opening. As shown on FIG. 3, at least a part of the airflow path 42 and the tag 26 extends in a same plane, notably a plane extending along the cartridge axis Y-Y′. In the same example, the tag 26 is arranged only on one side of the airflow path 42.

It will be apparent to those skilled in the art that the invention is capable of other embodiments and of being practiced or being carried out in various ways. For example, the tag 26 and the tag reader 24 may be offset along an axis perpendicular to the device axis X-X′.

1. An aerosol generation assembly comprising an aerosol generation device and a cartridge;
the aerosol generation device comprising a device body extending along a device axis (X-X′) and comprising:
a cavity delimited by a cavity surface and defining an operation position of the cartridge wherein the cartridge is received in the cavity and is configured to operate with the aerosol generation device, and
a tag reader arranged on the cavity surface and extending along an offset axis (A-A′);
the cartridge comprising a cartridge body defining a cartridge surface, and an electronic communication tag configured to store data and communicate the data to the tag reader when the cartridge is in the operation position;
wherein the electronic communication tag is arranged on the cartridge surface so as when the cartridge is in the operation position, the electronic communication tag and the tag reader are offset along the offset axis (A-A′).

2. The aerosol generation assembly according to claim 1, wherein the offset axis (A-A′) is parallel to the device axis (X-X′).

3. The aerosol generation assembly according to claim 1, wherein, when the cartridge is in the operation position, each of the electronic communication tag and the tag reader extends in a respective plane, wherein the two respective planes are separated and parallel.

4. The aerosol generation assembly according to claim 1, wherein, when the cartridge is in the operation position, the electronic communication tag and the tag reader are arranged away from each other along to the offset axis (A-A′) or overlap each other along the offset axis (A-A′) less than 25 % of the electronic communication tag area.

5. The aerosol generation assembly according to claim 1, further comprising a mouthpiece configured to cover a part of the cartridge body and defining an internal volume between at least a delimiting wall of said part and an internal surface of the mouthpiece, the electronic communication tag arranged in the internal volume.

6. The aerosol generation assembly according to claim 5, wherein the cartridge body comprises an airflow path defining an outlet formed on the mouthpiece, at least a part of the airflow path and the electronic communication tag extending in a same plane.

7. The aerosol generation assembly according to claim 6, wherein said part of the airflow path extends between the delimiting wall and a side wall of the cartridge body.

8. The aerosol generation assembly according to claim 1, wherein:
the cartridge body extends along a cartridge axis (Y-Y′) coinciding with the device axis (X-X′) when the cartridge is in the operation position;
the electronic communication tag extending parallel to the cartridge axis (Y-Y′).

9. The aerosol generation assembly according to claim 8, wherein the electronic communication tag extends in a plane extending at equidistance from two parallel side walls of the cartridge body.

10. The aerosol generation assembly according to claim 9, wherein, to be placed in the operational position, the cartridge is configured to be received in the cavity according to two different orientations, and the electronic communication tag is configured to communicate the data to the tag reader when the cartridge is in the operation position according to either orientation.

11. The aerosol generation assembly according to claim 1, wherein the cartridge body comprises a storage portion for storing an aerosol forming precursor and delimited by walls made of glass or plastic materials.

12. The aerosol generation assembly according to claim 1, wherein the tag reader includes a dielectric support, a chip and an antenna, the dielectric support is directly fixed to the cavity surface, and the dielectric support is devoid of ferrite.
